(19) United States
(12) Patent Application Publication
(10) Pub. No.: US 2002/0039853 A1
(43) Pub. Date: Apr. 4, 2002

(54) Connector

(76) Inventor: Bernhard Weingartner, Feldkirch (AT)

Correspondence Address: Neal L. Slifkin, HARRIS BEACH LLP, The Granite Building, 130 East Main Street, Rochester, NY, 14604-1687, US

(21) Appl. No.: 09/956,562

(22) Filed: Sep. 19, 2001

(30) Foreign Application Priority Data
Sep. 29, 2000 (DE) 100 48 507.3

(51) Int. Cl. H01R 13/213

(52) U.S. Cl. 439/314

(57) ABSTRACT

This invention relates to a plug part of a BNC plug-and-socket connection for a coaxial cable, which contains an external and an internal conductor, with plug body (1), comprising an external contact part (5) arranged in the front in relation to the direction of plugging, a connection zone (6) for fixing the external conductor of the coaxial cable, located at the back and connected in an electrically conductive manner with external contact part (5), and an internal insulated part (8) comprising a central aperture (9) for a contact pin (10), to which the internal conductor of a coaxial cable is to be connected, and a bayonet-type bushing (2) arranged on plug body (1) in a twistable manner, and furthermore, a manipulation casing (19) designed as a separate part, which is connected with bayonet-type bushing (2) in a firm, untwistable manner, overlaps connection zone (6) of plug part (1) at its rear side, and is used to open and close the BNC plug-and-socket connection through bayonet-type bushing (2).

### BACKGROUND OF THE INVENTION

a) Technical field of the invention:

This invention relates to a plug part of a BNC plug-and-socket connection for a coaxial cable with an external and an internal conductor, with a plug body comprising an external contact part arranged in the front in relation to the direction of plugging, a connection part located at the back and connected with the external contact part in an electrically conductive manner and serving for fixing the external conductor of the coaxial cable, and an insulated part located inside comprising a central aperture for the intake of a contact pin, to which the internal conductor of the coaxial cable can be connected, and finally with a bayonet-type bushing screwed on the plug body.

b) Description of the related state of art:

As is well known, a coaxial cable consists of an internal cylindrical conductor, mostly made of copper, an insulator arranged around this internal conductor also in a cylindrical shape, mostly made of polyethylene or Teflon, and another conductor arranged around the insulator in a cylindrical form, made preferably from silverplated braided copper wires or also from a foil (braided shield or foil shield). An external insulator is arranged around this external conductor. Various known connector systems are used to connect such a coaxial cable with a device or with another coaxial cable, of which the most frequently used are the so-called BNC plug-and-socket connections. These connections use a quarter-turn fastener for attaching the plug part to the connector socket. The quarter-turn fastener is formed, on the one hand, by a bayonet-type bushing screwed on the plug body of the plug part. On the other hand, the cylindrical casing of the connector socket comprises two opposed pins sticking out radially from the casing's perimeter. The bayonet-type bushing is inserted along corresponding grooves and over these pins-on the casing of the connector socket and is then fixed by twisting. A BNC plug-and-socket connection is described, e.g., in DE 187 23 050 C2.

Such BNC plug-and-socket connections proved their worth a million times, they are very strong and mechanically robust. However, especially with modem devices, e.g. a videocamera, which include a large number of plug-and-socket connections and control devices, the bayonet-type bushing arranged in the front end of the plug part is difficult to reach due to hindering adjoining connectors and controls. Therefore, the user can open and close a BNC plug-and-socket connections only with considerable difficulty.

### TASK AND SUMMARY OF THE INVENTION

An important task of this invention is to provide a plug part of a BNC plugand-socket connection of the aforementioned type, which is easier to open or close, especially in confined conditions. According to this invention, this is achieved for the aforementioned plug part by designing a casing as a separate part, which is connected with the bayonet-type bushing in an untwistable manner, overlaps the connection range of the plug part on the back end, and through which the bayonet-type bushing can be manipulated to open or close the BNC plug-and-socket connection.

Based on the manipulating casing according to this invention, by means of which the bayonet-type bushing can be manipulated to open or close the BNC plugand-socket connection, the manipulation range of the plug part according to this invention is no longer located at the front end of this plug part, which substantially simplifies its manipulation. Before connecting the coaxial cable to the plug part according to this invention, the manipulation casing is first inserted on the end of the cable to be connected, and only then is the cable connected to the plug part in the usual manner. The result is that the connection between the manipulation casing and the bayonet-type bushing is firm, untwistable. The preferred type of connection between the manipulation casing and the bayonet-type bushing—or a part firmly attached to this bushing—is a snap-on connection.

The preferred design is that the manipulation casing overlaps the coaxial cable at the zone adjoining to the plug part. This allows the manipulation casing to serve, at the same time, as a cable protector against bending immediately at the back end of the plug part.

The claims contain various characteristics and design versions of this invention.

Additional advantages and details of the invention will be explained in further text on an exemplary design illustrated in the drawing, from which other tasks of this invention become clear.

### SHORT DESCRIPTION OF THE DRAWINGS

The drawings show:

FIG. 1 shows an exploded perspective view of the plug part according to this invention., and FIG. 2 shows a side view of the plug part of FIG. 1, cross-section of its one half.

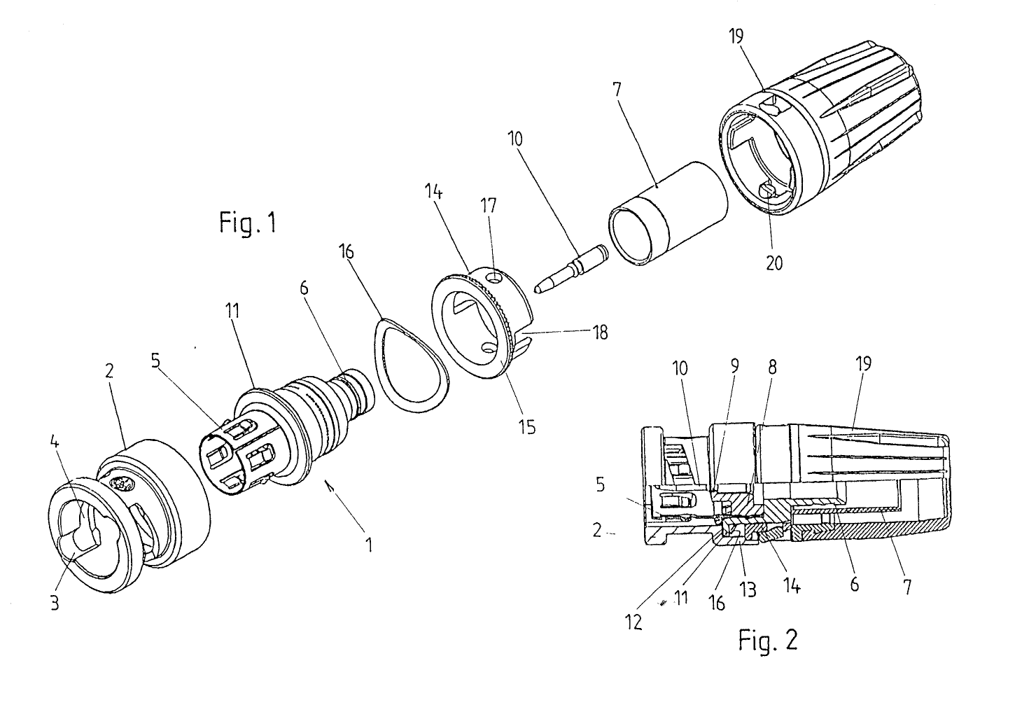

### DESCRIPTION OF THE PREFERRED DESIGN EXAMPLES

The design example of a plug part—according to this invention and as shown in the Figures—of a BNC plug-and-socket connection for a coaxial cable that contains an external and an internal conductor comprises a plug body 1, on which is introduced a bayonet-type bushing arranged in a twistable manner. Bayonet-type bushing 2 comprises, on its inner side, usual opposed grooves 3 with connected channels 4. To form a quarter-turn connection, through these grooves 3 and channels 4 the bayonettype bushing is inserted, over the opposed pins of the plug socket sticking out radially from a cylindrical casing, and then is interlocked with the plug socket.

Plug body 1 comprises an external contact part 5 arranged in the front in relation to the direction of plugging, and connected with a connection zone 6 located at the back in an electrically conductive manner. In the design example shown, this connection zone 6 is designed in the form of a crimp neck, on which the external conductor of the coaxial cable can be inserted and locked by means of a crimp barrel 7. An insulated part 8 is located inside plug body 1. The insulated part comprises a central aperture 9. After the internal conductor of the coaxial cable is soldered to one contact pin 10, this contact pin is inserted into this central aperture 9 of insulated part 8 and locked into place. (At the same time, the insulated external conductor is inserted on the connection zone 6 designed as a crimp neck and subsequently locked by a crimp barrel 7.

Plug body 1 further comprises an outstanding ring-shaped flange 11. This flange 11 is overlapped by a zone 13 of bayonet-type bushing 2 located at its rear end and adjoining to a shoulder 12. A split taper socket 14 also comprises an outstanding ring-shaped flange 15. This split taper socket 14 is pressed into zone 13 at the rear end of the bayonet-type bushing, where the outer edge of flange 15 adheres to the inner wall of zone 13 of bayonet-type bushing 2. An axial spring 16 is designed between flanges 1 1 and 15, which is supported by the opposed side surfaces of flanges 11 and 15, and prestresses the bayonet-type bushing into a rear position, where shoulder 12 and flange 11 sit close.

Split taper socket 14 further comprises, at its rear end, ring-shaped recesses 17 opposed to its cylindrical wall, and groove-like recesses 18 at its rear edge displaced by 90° in relation to recesses 17. These recesses 17 and 18 serve for an untwistable connection of split taper socket 14 with a manipulation casing 19. For this purposes, manipulation casing 19 comprises lugs 20 protruding inside, which can lock into ringshaped recesses 17 of split taper socket 14; the manipulation casing further comprises juts 21 projecting to the inside that can be inserted into groove-like recesses and then form an untwistable connection for split taper socket 14.Manipulation casing 19 allows to manipulate bayonet-type bushing 2 to open or close the BNC plug-andsocket connection. To allow an easy exertion of the manipulation force, the outer edge of manipulation casing 19 is equipped with knurling or other surface form.

There exist various modifications of the shown design example of the plug part without leaving the scope of this invention. For example, the connection of the external conductor of the coaxial cable can be designed also in other ways than crimping, for which purpose the connection zone must be designed in a corresponding manner. For example, the fixing of the external conductor could be done by means of a special part, which would then be screwed on or into an external or an internal thread of the plug part, which would firmly clamp the external conductor of the coaxial cable. The untwistable connection between manipulation casing 19 and bayonet-type busing 2 can also be designed in another way, e.g., by means of a thread connection, by gluing or by snapping on and shrinking. Instead of split taper socket 14, an immediate connection of the manipulation socket with bayonet-type bushing 2 can be used.

As becomes clear from the preceding description, this invention is not restricted to the design example shown in the drawing, but should rather be determined by the attached claims together with its fall scope.

While the preceding description and the drawings illustrate the invention, it is clear to an expert that various modifications can be performed without leaving the true spirit and scope of the invention.

1. A plug part of a BNC plug-and-socket connection for a coaxial cable that contains an external and an internal conductor, comprising a plug body (1) comprising an external contact part (5) arranged in the front in relation to the direction of plugging, a connection zone (6) for fixing the external conductor of the coaxial cable, located at the back and connected in an electrically conductive manner with external contact part (5), and an internal insulated part (8) comprising a central aperture (9) for a contact pin (10), to which the internal conductor of a coaxial cable is to be connected, a bayonet-type bushing (2) arranged on plug body (1) in a twistable manner, and furthermore, a manipulation casing (19) designed as a separate part, which is connected with bayonet-type bushing (2) in a firm, untwistable manner, overlaps connection zone (6) of plug part (1) at its rear side, and is used to open and close the BNC plug-and- socket connection through bayonet-type bushing (2).

2. Plug part according to claim 1, wherein connection zone (6) of plug body (1) is formed by a crimp neck of the plug body, to which the external conductor of the coaxial cable is fixed by a crimp barrel (7).

3. Plug part according to claim 1, wherein manipulation casing (19) is connected, in a firm and untwistable manner, with bayonet-type bushing (2) by a split taper socket (14) firmly attached to bayonet-type bushing (2), where split taper socket (14) comprises an outstanding ring-shaped flange (15), which seals the split taper socket in rear zone (13) of bayonet-type busing (2).

4. Plug part according to claim 3, wherein an axial spring (16) is designed between an outstanding ring-shaped flange (11) of plug body (1) and ring-shaped flange (15) of split taper socket (14), against whose restoring force the bayonet-type bushing (2) can be shifted forward in relation to the plug body. 5. Plug part according to claim 3, wherein manipulation casing (19) is connected with split taper socket (14) by an interlocking connection. 6. Plug part according to claim 1, wherein manipulation casing (19) overlaps the coaxial cable in its zone adjoining to the plug part.
